(19) United States
(12) Patent Application Publication
(10) Pub. No.: US 2024/0123595 A1
(43) Pub. Date: Apr. 18, 2024

(54) Method for Holding a Spindle of a Mobile Power Tool

(71) Applicant: Hilti Aktiengesellschaft, Schaan (LI)

(72) Inventor: Joachim WOERZ, Penzing (DE)

(21) Appl. No.: 18/477,083

(22) Filed: Sep. 28, 2023

(30) Foreign Application Priority Data
Oct. 12, 2022 (EP) 22201098.5

(51) Int. Cl. B25F 5/00; H02K 7/14; H02K 29/08; H02P 6/16; H02P 6/30

(52) U.S. Cl. CPC B25F 5/001; H02K 7/145; H02K 29/08; H02P 6/16; H02P 6/30

(57) ABSTRACT

A method for holding a spindle of a mobile power tool in order to allow an opening and/or a closing of a tool fitting by turning an operating part of the tool fitting relative to the spindle, where the spindle is rotationally coupled to an electric motor. The method includes detecting a rotation of the spindle and/or of the electric motor in a first direction while a setpoint angular velocity is zero and controlling the electric motor to generate a torque in a second direction which is opposite to the first direction.

### CROSS REFERENCE TO RELATED APPLICATION

This application claims priority under 35 U.S.C. § 119 from European Patent Application No. 22201098.5, filed Oct. 12, 2022, the entire disclosure of which is herein expressly incorporated by reference.

### BACKGROUND AND SUMMARY OF THE INVENTION

The present invention relates to a method for holding a spindle of a mobile power tool, a computer program product, and a mobile power tool.

Mobile power tools are characterized by tool fittings for changing a tool. A so-called 3-jaw chuck is a known example of a tool fitting for mobile power tools of the power drill type. Screw-type fuses are common, for example, for hand-held power saws or grinding machines.

To receive or remove a tool, part of the tool fitting is rotated or turned relative to a spindle of the power tool. In order to apply the necessary torque without the use of tools, a counter-holding means is required on the spindle. Various blocking mechanisms are known for blocking the spindle. One example for this is a clamping mechanism with clamping rollers which are arranged so as to jam radially as a result of being driven by the tool fitting and to be released as a result of being driven by the spindle. The parts of the blocking mechanism close due to the effective forces and torques.

Against this background, the object of the present invention is to provide a means for counter-holding a spindle with reduced wear.

Accordingly, a method for counter-holding a spindle of a mobile power tool is provided in order to allow a tool fitting to be opened and/or closed by turning at least one operating part of the tool fitting relative to the spindle. In this case, the spindle is rotationally coupled to an electric motor of the power tool. The provided method comprises the following steps: detecting a direction of rotation of the spindle and/or of the electric motor whilst a setpoint angular velocity is zero; and controlling the electric motor to generate a torque by the electric motor which is directed oppositely to the detected rotation.

By means of the method, the blocking mechanism, which is susceptible to wear, is replaced by an open-loop control method and/or closed-loop control method (feedback control method). The blocking mechanism can thus be spared. Consequently, a mobile power tool with reduced susceptibility to wear is obtained.

The setpoint angular velocity is preferably given from an actuation state of an operating element.

Preferably, the provided method proposes one of the following advantageous developments or a combination thereof.

According to a preferred embodiment, the control of the electric motor includes: generating a current signal at the electric motor which is suitable for generating the torque by the electric motor.

The method optionally comprises: providing a rule, in particular a calculation rule, and/or a table which specifies a setpoint value of the torque, a current strength and/or a voltage in dependence on a value of the detected rotation and/or a control value of a supply circuit of the electric motor depending on the value of the detected rotation. Here, the control preferably includes controlling the electric motor to generate the value of the torque specified by the rule. The counter-holding by the electric motor can be optimized by means of the rule.

The table can specify a torque value and/or a current strength value and/or a voltage value and/or a control value, for example for each of a plurality of different angles of rotation and/or for each of a plurality of different angular velocities. A plurality of tables can be provided for different scenarios, such as for different ambient temperatures and/or for different fittings on the power tool. The option has the advantage of being realizable with little effort by a control device of the power tool.

The calculation rule can be implemented in particular as an equation and/or a function. This option has the advantage that the value of the torque that can be generated can be determined very finely.

The rule is preferably designed such that an upswing and/or an oscillation around a zero position is prevented or avoided. For example, a hysteresis and/or a damping member can be provided.

The control of the electric motor can include, for example, a specification in particular of a torque value, a current strength value and/or a voltage value at the electric motor.

The control of the electric motor can include, in particular, an operation of a supply circuit by means of the control value.

The detection of the direction of rotation of the spindle and/or of the electric motor can have application-related advantages. For example, advantages in respect of installation space or the presence of a rotation sensor, in particular on the electric motor, can be used.

The detection of the direction of rotation preferably includes a detection of an angle of rotation. A rotation of the spindle and/or of the electric motor can thus be identified reliably, even at relatively low angular velocities.

The detection of the direction of rotation preferably includes a detection of an actual angular velocity. The current state of rotation can be estimated precisely and used to measure the torque.

The rule preferably indicates the setpoint value and/or the control value in dependence on a value of the actual angular velocity in order to quickly bring the detected angular velocity to zero.

The electric motor is preferably controlled to stop the detected rotation. This option is insensitive to an oscillation around a zero position. In addition, it may be sufficient for the purpose of counter-holding to open or close the tool fitting, that a spinning of the spindle or of the electric motor is suppressed.

The electric motor is optionally controlled to reset the detected rotation. This option feels stiff to a user and therefore has a high customer acceptance.

In order, for example, to respond to a temporally changing operation of the operating part of the tool fitting, the provided steps are preferably carried out repeatedly. For example, the steps are performed in a loop or at certain moments in time.

The method can be triggered, for example as a result of pressing a button or another actuation of an actuation element. The method can also be carried out constantly or repeatedly, provided the power tool is switched on. The method can also be carried out constantly or repeatedly, provided the power tool is connected to a power source, such as an accumulator.

A computer program product is also provided, which comprises instructions which, when the program is executed by a computer, cause the latter to carry out the above-described method.

A computer program product, such as for example a computer program means, can be provided or supplied, for example, as a storage medium, such as for example a memory card, USB stick, CD-ROM, DVD, or in the form of a downloadable file from a server in a network. This can be carried out, for example, in a wireless communication network by transmitting a corresponding file with the computer program product or the computer program means.

A mobile power tool is also provided. This comprises: an electric motor; a spindle, which is rotationally coupled to the electric motor; a tool fitting which can be opened and/or closed by turning an operating part of the tool fitting relative to the spindle; a rotation sensor which is suitable and arranged for detecting a rotation of the spindle and/or the electric motor; and a control device which is connected to the rotation sensor and the electric motor and which is set up to carry out the method for counter-holding the spindle of the mobile power tool.

The embodiments and features described for the provided method apply correspondingly to the provided power tool.

The tool fitting is preferably suitable for receiving a tool. The tool fitting is preferably suitable and/or connected, for example rotationally coupled, for transferring rotary power between the spindle and the tool.

According to a preferred embodiment, the electric motor is a brushless DC motor. This design is characterized by low wear.

The rotation sensor is preferably designed to detect an angle of rotation and/or an angular velocity. The rotation sensor can be provided as a component that measures rotation directly or as a module of this kind. The rotation sensor can also be embodied as a function of the electric motor which concludes that the electric motor is rotating in dependence on a current and/or voltage profile thereof. The rotation sensor is particularly preferably embodied as a Hall sensor, which in particular is arranged to directly detect a rotation of a rotor or a shaft of the electric motor.

The mobile power tool may be a hand-held power tool, for example a drill, a screwing machine, a chiselling machine, a grinding machine, a saw or the like. It is also conceivable that the mobile power tool is a construction robot or comprises a construction robot. The mobile power tool may have a manipulator, in particular a multi-axis manipulator. The mobile power tool may have a drive device for driving a tool, for example a drill, a chisel, a suction device or the like.

The mobile power tool may be set up for processing concrete and/or metal. It may be designed for drilling, chiselling, sawing and/or grinding.

In general, the mobile power tool may be set up for carrying out work in building construction and/or civil engineering. It is conceivable that it is not set up for use in mining.

The mobile power tool may be portable; it may for example have a weight of less than 50 kg, in particular of less than 25 kg.

Further possible implementations of the invention also include combinations, not explicitly stated, of features or embodiments described previously or hereinafter in relation to the exemplary embodiments. A person skilled in the art will also add individual aspects as improvements or supplementations to the respective basic form of the invention.

Further advantageous embodiments and aspects of the invention are the subject of the dependent claims and also the exemplary embodiments of the invention described hereinafter. The invention will be explained in greater detail below on the basis of preferred embodiments with reference to the appended figures.

### BRIEF DESCRIPTION OF THE DRAWINGS

FIG. 1 shows a mobile power tool according to an embodiment of the invention; and

FIG. 2 shows a flow diagram of a method according to the invention.

### DETAILED DESCRIPTION OF THE DRAWINGS

In the figures, like or functionally like elements have been provided with the same reference signs, unless stated otherwise.

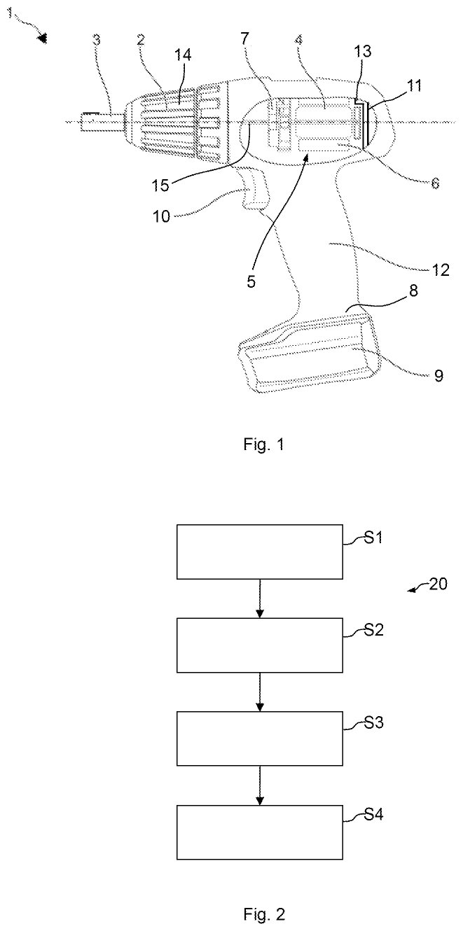

FIG. 1 shows a mobile power tool 1. The power tool 1 is, for example, a hand-held power tool, more specifically a drill. Further preferred embodiments include a grinding machine or a saw.

The power tool 1 has a tool fitting 2 for receiving a tool 3. The tool 3 can be driven in rotation via the tool fitting 2 by a rotor 4 of an electric motor 5.

The electric motor 5 is a brushless DC motor. It has a stator 6, which can be supplied with electric current in order to generate a torque between the stator 6 and the rotor 4.

The electric motor 5 and the tool fitting 2 are switchably or non-switchably rotationally coupled to a reduction gearing 7.

The tool fitting 2, the electric motor 5, the reduction gearing 7, a fitting 8 for a replaceable battery 9, at least one actuation element 10, and a control device 11 are mounted by a housing 12 and functionally connected in the usual way.

The power tool 1 enables a cordless operation. The battery 9 comprises lithium.

The power tool 1 is configured as a portable device. It has a weight of between 0.5 and 15 kg and generally of less than 25 kg.

The control device contains at least one Hall sensor 13, which is designed and arranged to detect an angle of rotation and an angular velocity of the rotor 4 relative to the housing 12.

The tool fitting 2 has a radially externally arranged handle 14, which is part of the tool fitting 2. Viewed from the electric motor 5, a spindle 15 is arranged downstream of the reduction gearing 7 and is suitable for rotational power transfer to the tool fitting 2.

By turning the grip 14 relative to the spindle 15, a chuck (not shown) of the tool fitting 2 can be opened and/or closed.

The control device 11 is set up to execute a computer program, the instructions of which cause the control device to carry out a method 20 shown in FIG. 2.

In particular, the control device 11 for example has an evaluation logic, which is set up to evaluate a sensor signal of the Hall sensor 13, a computing logic for carrying out methods, and a control logic for controlling the electric motor 5. This configuration is one example and in particular a fully integrated circuit is also conceivable.

If a setpoint angular velocity of the electric motor 5 is zero, for example because the actuation element 10 is not actuated, a first step S1 is performed. The method 20 is started for example in step S1. The step S1 is preferably carried out at fixed intervals, for example with a frequency of 20 Hz.

In a next step S2, a state of rotation of the rotor 4 relative to the Hall sensor 13, which is fixed to the housing, is detected by the Hall sensor 13. The state of rotation can assume in particular a rotation process or a non-rotation process.

Here, the control device 11 detects an angle of rotation between the rotor 4 and the housing 12.

The control device 11 preferably detects an absolute change to the angle of rotation since a switch-on of the power tool 1, a last switch-off of the electric motor 5, and/or a connection of the battery 9 to the fitting 8.

Furthermore, the control device 11 detects an actual angular velocity between the Hall sensor 13 and the housing 12.

Because the reduction gearing 7 is connected between the spindle 15 and the rotor 4, the Hall sensor 13 is advantageously very sensitive to a rotation of the spindle 15 relative to the housing 12.

In a next step S3, a rule is provided. To this end, a table is loaded and/or read out from a memory of the control device 11.

The control device 11 obtains, from the rule, a torque value which is suitable for stopping the actual angular velocity. The torque values of the rule are in the present case designed to stop a rotation process of the spindle.

Optionally, the torque values of the rule are even designed to reset the spindle.

A torque value which is suitable for the detected actual angular velocity is thus obtained by means of the rule.

In a step S4 the electric motor 5 is then controlled in order to generate a torque which is counter to a detected rotation. To this end, the electric motor 5 is controlled with the obtained torque value.

The torque value is preferably embodied as a voltage value and/or a current strength value. Alternatively, a control value and/or an operating value is provided, which is suitable for operating a supply circuit (not shown) connected between the battery 9 and the electric motor 5 to generate the torque appropriate for stopping the rotation.

If, in step S1, a rotation of the spindle 15 is detected, which is not caused by a control of the electric motor 5, the electric motor 5 is thus controlled in step S4 in order to stop this actual rotation. The electric motor 5 thus causes the spindle 15 to be held in place.

If a user turns the grip 14 to open or close the tool fitting 2, and if the spindle 15 is thus rotated, the electric motor 5 thus rotationally holds part of the tool fitting 2. Consequently, a tool change can be performed quickly and safely for a user by the user. The method 20 thus causes an electric spindle lock or an electric holding of the spindle 15. Here, there is no wear of the spindle 15 or of the electric motor 5.

The method 20 is thus suitable and effective for holding a spindle of the mobile power tool 1 in order to allow an opening and/or closing of the tool fitting 2 by a turning of an operating part of the tool fitting 2 relative to the spindle 15.

Although the present invention has been described on the basis of exemplary embodiments, it can be modified in many ways.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE CHARACTERS

1 power tool
2 tool fitting
3 tool
4 rotor
5 electric motor
6 stator
7 reduction gearing
8 fitting
9 battery
10 actuation element
11 control device
12 housing
13 Hall sensor
14 grip
15 spindle
20 method
S . . . step

What is claimed is:

1. A method for holding a spindle of a mobile power tool in order to allow an opening and/or a closing of a tool fitting by turning an operating part of the tool fitting relative to the spindle, wherein the spindle is rotationally coupled to an electric motor, comprising the steps of:
detecting a rotation of the spindle and/or of the electric motor in a first direction while a setpoint angular velocity is zero; and
controlling the electric motor to generate a torque in a second direction which is opposite to the first direction.

2. The method according to claim 1, further comprising the step of:
providing a calculation rule or a table which specifies a setpoint value of the torque depending on a value of the detected rotation;
wherein the controlling of the electric motor generates the torque at the setpoint value.

3. The method according to claim 1, further comprising the step of:
providing a calculation rule or a table which specifies a control value of a supply circuit of the electric motor depending on a value of the detected rotation;
wherein the controlling of the electric motor includes operating the supply circuit with the control value.

4. The method as claimed in claim 2, wherein the detecting of the rotation includes detecting an actual angular velocity and wherein the calculation rule specifies the setpoint value of the torque depending on a value of the actual angular velocity.

5. The method according to claim 1, wherein the electric motor is controlled to stop the detected rotation.

6. The method according to claim 1, wherein the electric motor is controlled to reset the detected rotation.

7. The method according to claim 1, wherein the steps are performed repeatedly.

8. A computer program product comprising instructions which, when the computer program is executed by a computer, cause the computer to execute the method according to claim 1.

9. A mobile power tool, comprising:
an electric motor;
a spindle which is rotationally coupled to the electric motor;
a tool fitting which is openable and/or closable by turning an operating part of the tool fitting relative to the spindle;
a rotation sensor, wherein a rotation of the spindle and/or of the electric motor is detectable by the rotation sensor; and
a control device which is connected to the rotation sensor and the electric motor, wherein the control device is configured to perform the method according to claim 1.

10. The mobile power tool according to claim 9, wherein the electric motor is a brushless DC motor.

11. The mobile power tool according to claim 9, wherein an angle of rotation and/or an angular velocity is detectable by the rotation sensor.

12. The mobile power tool according to claim 9, wherein the rotation sensor includes at least one Hall sensor.
